(19) United States
(12) Patent Application Publication
(10) Pub. No.: US 2013/0127863 A1
(43) Pub. Date: May 23, 2013

(54) DETERMINING AN OPTIMAL SEQUENCE OF STATUS TRANSITIONS FOR BUSINESS OBJECTS

(71) Applicants: Steffen WITT, Heidelberg (DE); Matthias BECKER, Bruchsal (DE); Oliver BERGER, Hockenheim (DE); Torsten BUECHELER, Speyer (DE); Knut HEUSERMANN, Bad Schoenborn (DE); Christian HOHMANN, Mannheim (DE)

(72) Inventors: Steffen WITT, Heidelberg (DE); Matthias BECKER, Bruchsal (DE); Oliver BERGER, Hockenheim (DE); Torsten BUECHELER, Speyer (DE); Knut HEUSERMANN, Bad Schoenborn (DE); Christian HOHMANN, Mannheim (DE)

(21) Appl. No.: 13/303,165

(22) Filed: Nov. 23, 2011

(51) Int. Cl. G06T 11/20

(52) U.S. Cl. 345/440

(57) ABSTRACT

Various embodiments of systems and methods for determining optimal an sequence of status transitions for business objects are described herein. In one aspect, the method executed by one or more computers in a network of computers includes receiving a target status for a business object, identifying a source status of the business object, identifying a status schema including one or more transitions from the source status to the target status, parsing the status schema to retrieve the one or more transitions from the source status to the target status, generating a graphical representation illustrating the transitions from the source status to the target status, executing an algorithm upon the graphical representation to determine an optimal sequence of transitions from the source status to the target status, and processing the business object based upon the optimal sequence of transitions to attain the target status.

### BACKGROUND

Business object (BO) is a representation of a business entity used in a software solution, e.g., an employee, a customer, a purchase order, and a supplier invoice, etc. Typically, the BO includes data related to the business entity and one or more functions (processes) performed by the business entity. Each business object has various statuses or states, e.g., ‘new,’ ‘obsolete,’ ‘active,’ ‘in preparation,’ etc. The BO may switch from one status to another status, i.e., a transition from one status to another. A transaction may involve an action call, i.e., a call or operation to be performed on the BO to switch the BO from one status to another. For example, if the BO is in ‘active’ status then a destroy operation may be performed on the BO to bring it to ‘deleted’ status. Usually, a user specifies a desired status (target status) for the BO. The target status may be specified or provided by the user through a Web service at runtime. A sequence of transitions may be required to attain the target status. For example, if the user desires to create a new BO (e.g., a customer) in the ‘active’ status then the following sequence of transitions (e.g., T1-T3) may be required to attain the ‘active’ status from the ‘new’ status:

Transition (T1): new→in preparation;

Transition (T2): in preparation→review;

Transition (T3): review→active.

Usually, all valid transitions from one status (e.g., ‘new’) to another status (e.g., ‘active’) are defined in a status schema or a state diagram of the BO. The transitions following the status schema are valid transitions. Typically, a software developer consults the status schema to hardcode all valid paths from one status to another status in a Web service. The Web service receives the target status from the user and identifies the source or current status of the BO from a variable associated with the BO. Based upon the target status and the source status, the Web service selects a first valid hardcoded path from the source status to the target status. The Web Service executes the selected hardcoded path to attain the target status.

However, it may be a waste of resources, time, and effort to explicitly code (hardcode) all valid paths or transitions. Further, hardcoding all possible paths is an error prone process. Moreover, if the status schema is revised or updated, e.g., a new status added, an old status is edited or deleted, etc., then the hardcoded paths are also required to be revised by the software developer. Again, it requires an extra effort to keep track on the changes and hardcode the paths manually. Additionally, the hardcoded path selected by the Web Service to attain the target status may not be efficient (i.e., may not be a shortest path). Also, since each transition requires time consuming action calls, the number of action calls and hence the number of status transitions should be minimized. Finally, if the status schema includes a loop or a circular transition, e.g., status A→B, B→C, C→B, and C→D, and the Web Service executes an algorithm (e.g., greedy algorithm) for determining the path from the source to the target status then it might be possible that the BO goes into infinity loop between B→C and C→B repeatedly. Typically, the BO could not identify any paths between A→D and might display an error message stating that the target status cannot be attained.

### SUMMARY OF THE INVENTION

Various embodiments of systems and methods for determining optimal sequence of status transitions for business objects are described herein. In one aspect, the method executed by one or more computers in a network of computers includes receiving a target status for a business object, identifying a source status of the business object, identifying a status schema including one or more transitions from the source status to the target status, parsing the status schema to retrieve the one or more transitions from the source status to the target status, generating a graphical representation illustrating the transitions from the source status to the target status, executing an algorithm upon the graphical representation to determine an optimal sequence of transitions from the source status to the target status, and processing the business object based upon the optimal sequence of transitions to attain the target status.

These and other benefits and features of embodiments of the invention will be apparent upon consideration of the following detailed description of preferred embodiments thereof, presented in connection with the following drawings.

### BRIEF DESCRIPTION OF THE DRAWINGS

The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow chart illustrating the steps performed to determine an optimal sequence of status transitions from a source status to a target status for a business object, according to various embodiments of the invention.

FIG. 2 is a block diagram of a system including an optimal path determining module to determine an optimal sequence of transitions from a source status to a target status for a business object, according to an embodiment of the invention.

FIG. 3 illustrates a block diagram of an exemplary status schema, according to an embodiment of the invention.

FIG. 4 is a block diagram of the optimal path determining module, according to an embodiment of the invention.

FIG. 5 illustrates a graph generated by a graph generating module using the status schema of FIG. 3, according to an embodiment of the invention.

FIG. 6 illustrates another exemplary graph generated by the graph generating module, according to an embodiment of the invention.

FIG. 7 illustrates an internal representation of the graph of FIG. 6 in a tabular format, according to an embodiment of the invention.

FIG. 8 is a flow chart illustrating the steps performed by the optimal path determining module to find the optimal sequence of transition from the source status to the target status, according to an embodiment of the invention.

FIG. 9 is a block diagram of an exemplary computer system, according to an embodiment of the invention.

### DETAILED DESCRIPTION

Embodiments of techniques for optimal sequences of status transitions for business objects are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

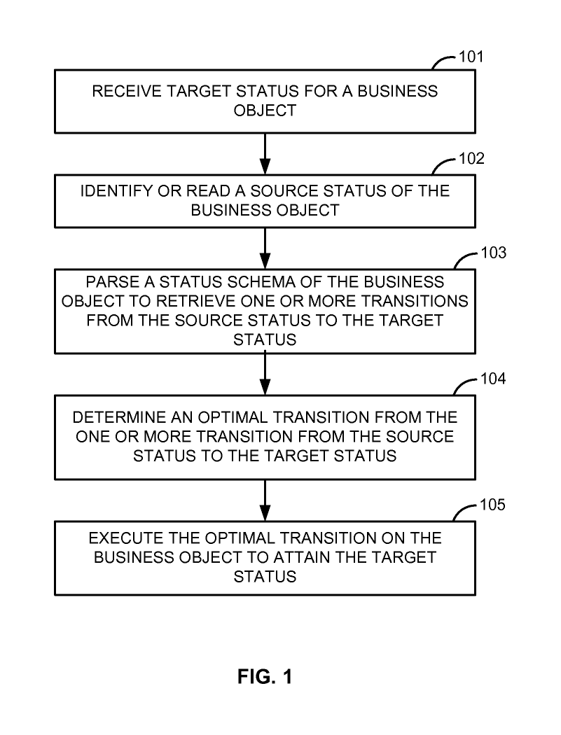

FIG. 1 is a flowchart illustrating a method for determining an optimal sequence of status transition from a source status to a target status for a business object, according to one embodiment. Typically, the target status for the business object (BO) is received at step 101. The target status may be received as a Web service request (e.g., an XML Web service request). Once the target status is received, the source or current status of the BO may be identified or read from a variable associated with the BO at step 102. Typically, the BO itself includes a field (e.g., a lifecycle status variable) that indicates the source status or current status of the BO. Based upon the source status and the target status, a status schema of the BO may be parsed. Typically, the status schema of the BO includes one or more paths (sequences of transitions) from the source status to the target status. The status schema may be parsed to retrieve the one or more paths from the source status to the target status at step 103. An algorithm (e.g., Breadth First Search algorithm) may be executed to determine an optimal sequence of status transitions from the one or more transitions at step 104. Typically, the one or more transitions may be represented graphically and the algorithm may be executed upon the graphical representation to determine the optimal sequence of status transition from the source status to the target status. Finally, the optimal sequence of status transition is executed on the business object to attain the target status at step 105.

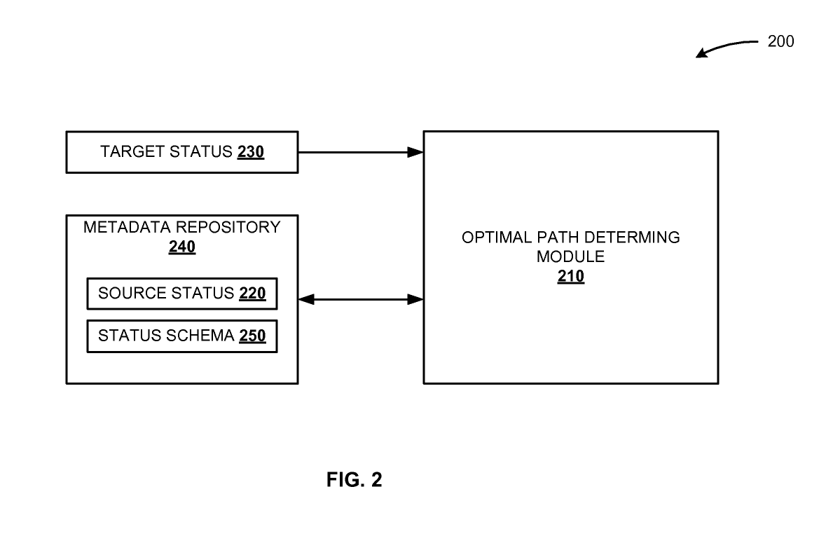

FIG. 2 illustrates one embodiment of a system 200 including an optimal path determining (OPD) module 210 to determine an optimal path (e.g., sequence of status transitions) for the business object (not shown) from a source status 220 to a target status 230 (e.g., according to FIG. 1). The target status 230 may be specified by a user (e.g., a consumer) through a web service request (not shown). The source status 220 may be identified or read from a variable associated with the BO. A metadata repository 240 includes a status schema 250 defined for the BO. The status schema 250 includes one or more paths (sequences of transitions) from the source status 220 to the target status 230. Typically, the OPD module 210 automatically determines the optimal path (optimal sequences of status transitions) from the source status 220 to the target status 230 for the BO using the status schema 250.

The target status 230 is a desirable status of the BO specified by the user or consumer. Typically, the target status 230 is specified through the Web services or the Web server. The user may define the target status 230 for an existing BO or a newly created BO. Once the target status 230 is specified, the OPD module 210 identifies the source status 220 of the BO. The source status 220 of the BO may be identified from the BO. Typically, the BO includes a field indicating a status variable (e.g., a lifecycle status variable) that indicates the source or current status 220 of the BO. In one embodiment, various transitions related to the source status 220 of the BO may be stored in the metadata repository 240.

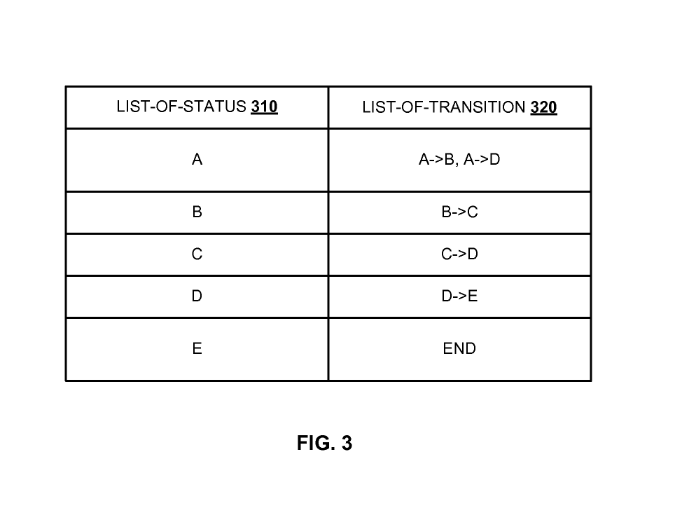

Typically, the metadata repository 240 includes the status schema 250 related to the BO. The status schema 250 may illustrate various statuses (e.g., list-of-status 310) for the BO and various valid transitions (e.g., list-of-valid transitions 320) for each status of the BO, as illustrated in FIG. 3. For example, the list-of-statuses 310 illustrates various statuses (A-E) for the BO. Similarly, the list-of-transitions 320 illustrates valid transitions for each status (A-E). For example, for status A, the valid transitions are (A→B, A→D), for status B the valid transitions are (B→C, B→E), for status C the valid transition is (C→D), and for status D the valid transition is (D→E), as illustrated in FIG. 3.

The status schema 250 may be parsed or read to identify or retrieve one or more valid sequences of transitions to attain the target status 230 from the source status 220. For example, if the source status 220 is ‘A’ and the target status 230 is ‘E’, then the following sequences of transitions may be retrieved to attain the target status 230 (i.e., E) from the source status 220 (i.e., A):

i.) A→B→C→D→E; and

ii.) A→D→E.

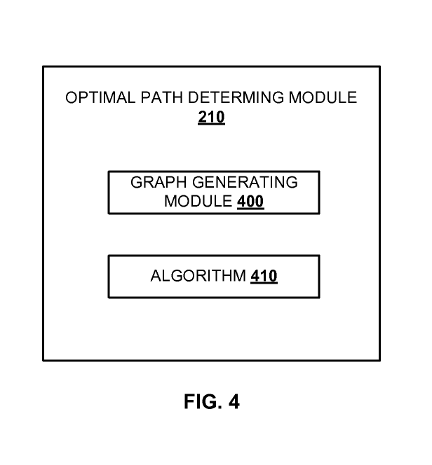

In one embodiment, the OPD module 210 is associated with a graph generating module 400 (shown in FIG. 4) to parse the status schema 250 to identify the sequences of transitions (i and ii). In one embodiment, the graph generating module 400 may be included within the OPD module 210, as illustrated in FIG. 4. In another embodiment, the graph generating module 400 may be a separate entity communicatively coupled to the OPD module 210. Typically, the graph generating module 400 may parse the status schema 250 to retrieve or identify one or more paths (e.g., transitions i and ii) from the source status 220 (i.e., A) to the target status 230 (i.e., E). Once the one or more paths (e.g., transitions i and ii) are identified, the graph generating module 400 generates a graphical representation of the one or more paths (e.g., transitions i and ii) from the source status 220 (i.e., A) to the target status 230 (i.e., B).

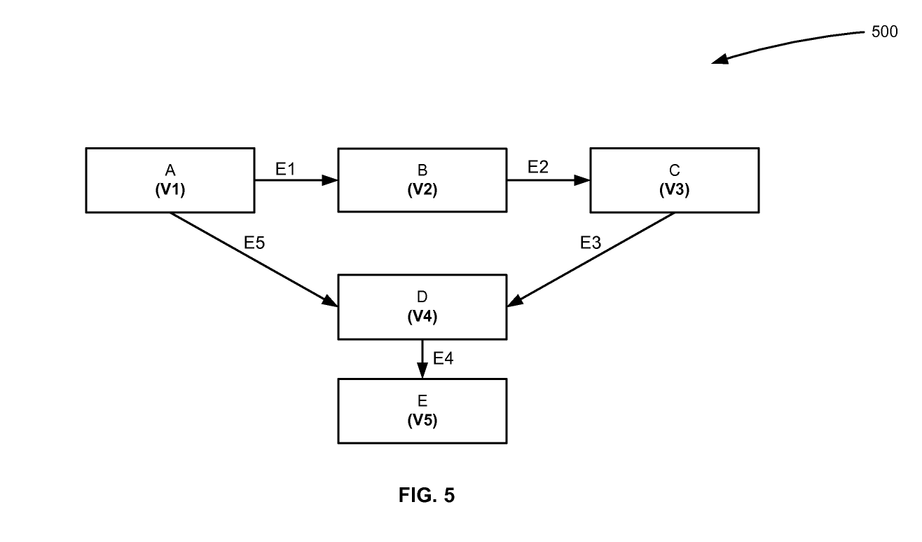

The graphical representation may be any suitable data structure illustrating the one or more sequences of transitions (e.g., i and ii) from the source status 220 (i.e., A) to the target status 230 (i.e., E). For example, the graphical representation may be a graph 500 (FIG. 5) illustrating the one or more sequences of transitions (e.g., i and ii) from the source status 220 (i.e., A) to the target status 230 (i.e., E). Typically, the graph 500 may be generated by using any suitable graph generating technique or algorithm. The graph 500 includes statuses (A-E) as vertices (V1-V5) and the transition between each status may be represented as an edge (E1-E5). For example, the transition between A→B may be represented by the edge E1, as illustrated in FIG. 5. In one embodiment, each transition or edge (E1-E5) may be assigned or allocated a predefined value (e.g., 1 unit). In another embodiment, each transition or edge (E1-E5) represents an action performed on the BO. For example, the transition from status ‘A’ to status ‘B’ (i.e., edge E1) may be attained by performing a particular action on the BO. In one embodiment, the graph 500 may be stored internally in a tabular format (not shown). The tabular format may include a list of vertices and a list of edges. In one embodiment, the tabular format of the graph 500 may be stored in a memory (e.g., RAM). In another embodiment, the tabular format of the graph 500 may be stored in a metadata repository 240.

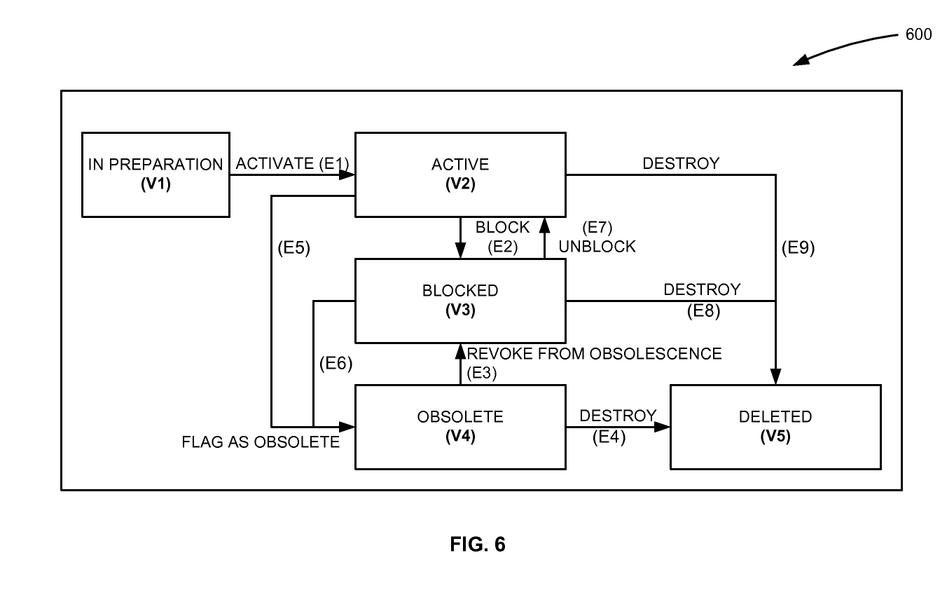

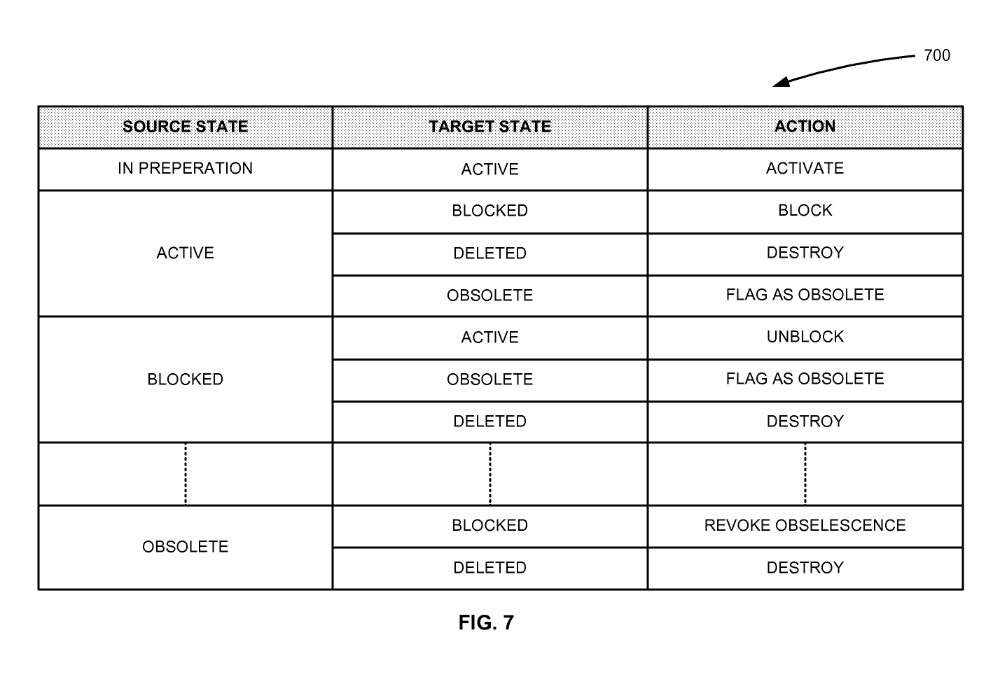

In one embodiment, as illustrated in FIG. 6, a graph 600 may be generated for the BO (e.g., customer). The graph 600 includes statuses namely ‘in preparation,’ ‘active,’ blocked,“obsolete,' and ‘deleted’ as vertices V1-V5, respectively. Further, the edges represent the action performed on the BO (customer) while performing the transition from one status to another. For example, if the BO (customer) is in the ‘active’ status then a ‘destroy’ operation may be performed on the BO (customer) to reach the ‘deleted’ status. Similarly, if the BO (customer) is in ‘blocked’ status then an ‘unblock’ operation may be performed on the BO (customer) to bring it back to the ‘active’ status. Typically, each of action/operation is performed in a specific status and changes the status during execution. For example, the action “activate” can only be enabled in the status ‘in preparation’ and leads to the target status “active.” Similarly, for the status “active” the actions “destroy,” “FlagAsObsolete,” and “blocked” are valid transitions/actions. The graph 600 may be stored or represented internally in a tabular format 700 (shown in FIG. 7). The tabular format 700 may include possible transitions from the source status to the target status (source→target) and an appropriate action or operation to be performed to reach the respective target statuses from the source statues.

Once the graphical representation (e.g., the graph 600 or 500) is generated, the OPD module 210 executes an algorithm 410. Typically, the algorithm 410 is executed upon, e.g., the graph 500 to determine the optimal path or status of transitions from the source status 220 (i.e., A) to the target status 230 (i.e., E). The algorithm may be a breadth first search algorithm (e.g., Dijkstra's algorithm). Typically, the Dijkstra's algorithm may find a shortest path (sequence of transitions or actions) from the source status ‘A’ to the target status ‘E.’ For example, the Dijkstra's algorithm may determine the transition A→D→E as the shortest transition or optimal sequences of transitions from the source status A to the target status E. Similarly, with respect to FIG. 6, the Dijkstra's algorithm may determine the transition ‘in preparation’→‘active’→‘deleted’ as the shortest transition or optimal sequences of transitions from the source status ‘in preparation’ to the target status ‘deleted.’

Typically, each transition involves the action or operation to be performed on the BO. For example, for the transition from ‘in preparation’ to ‘active,’ the action ‘activate’ has to be performed on the BO. Similarly, for the transition from ‘active’ to ‘deleted’ the action ‘destroy’ has to be performed on the BO. Therefore, for the sequence of transition ‘in preparation’→‘active’→‘deleted,’ a corresponding sequence of actions ‘activate’ and ‘destroy’ has to be performed on the BO. Once the optimal path (sequence of transitions) from the source status 220 to the target status 230 is determined, the corresponding sequence of actions are executed to attain the target status 230. Typically, the shortest sequence of actions is determined to attain the target status 230.

In one embodiment, one or more predefined conditions may be fulfilled before attaining the target status 230 (i.e., E). For example, if the source status 220 (i.e., A) is ‘New’ for the BO (e.g., customer) and the target status 230 (i.e., E) is ‘Active’ then the information (e.g., name, address, etc) related to the BO or customer must be provided before reaching the target or ‘Active’ status (active status being the status ready to be used in a software solution). Typically, a Web Service (not shown) may determine if one or more predefined conditions are fulfilled or satisfied before reaching or achieving the target status 220.

In another embodiment, if the one or more predefined conditions are not fulfilled, an error message may be displayed on a user interface (UI). For example, the error message may be a prompt for entering required information (e.g., name and address) related to the BO. Once the target status 220 is attained, an XML response may be sent to the user or a confirmation message may be rendered on the UI. Further, the lifecycle status variable of the BO may be updated. For example, if the target status 230 is ‘active’ then the lifecycle status variable may be updated as ‘active.’ Typically, the status variable may be updated or keeps on changing as the status of the BO changes.

The embodiments enable the execution of the shortest path or the shortest sequence of action that requires less number of time consuming and costly calls. For example, the shortest path from the source status 220 (e.g., A) to the target status 230 (e.g., E) may be determined as A→D→E that requires only two calls (A→D and D→E) instead of A>B→C→D→E that requires four calls (A→B, B→C, C→D, and D→E). Importantly, it may be appreciated that if 2000 BOs are required to be transferred from one system to another in the target status 230 (i.e., E) from the source status 220 (i.e., A) then the system may require only 2*2000 or 4000 calls instead of 4*2000 or 8000 calls.

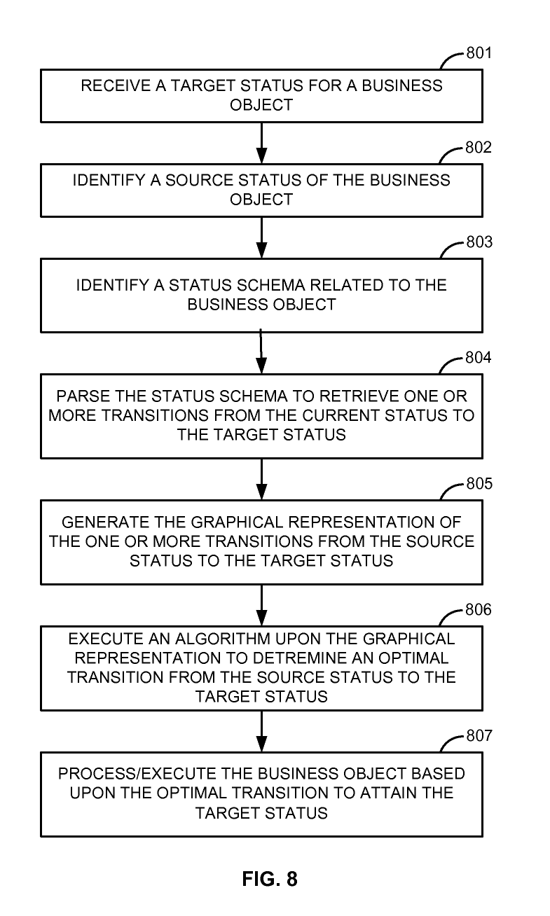

FIG. 8 is a flowchart illustrating a method for determining the optimal sequence of transitions from the source status 220 to the target status 230 for the BO. Typically, the target status 230 for the BO is received from the user at step 801. The target status 230 of the BO may be received as the Web service request (e.g., an XML Web service request) at runtime. Once the target status 230 is received, the graph generating module 400 identifies the source status 220 of the BO at step 802. Essentially, the source status of the BO may be determined or identified from the BO. Typically, the BO includes the lifecycle status variable that indicates the source or current status of the BO. In one embodiment, the source status may be identified from the variable associated with the BO. Various transitions for the source status may be stored in the metadata repository 240. Typically, the metadata repository 240 stores the status schema 250 of the BO. The status schema 250 includes the one or more transitions from the source status 220 to the target status 230. The status schema 250 related to the BO may be identified at step 803. The graph generating module 400 may parse the status schema 250 to retrieve or determine the one or more sequences transitions from the source status 220 to the target status 230 at step 804. Based upon the retrieved one or more sequences of transitions, the graph generating module 400 generates the graphical representation illustrating the one or more sequences of transition from the source status 220 to the target status 230 at step 805. Once the graphical representation is generated, the optimal path finding module 210 executes the algorithm 410 upon the graphical representation to determine the optimal sequences of transition from the source status 220 to the target status 230 at step 806. Finally, the business object (BO) is processed or executed based upon the optimal sequences of transition to attain the target status 230 at step 807.

The embodiments provide optimal (e.g., shortest) path or sequence of transitions to attain the target status. The execution of the optimal path provides an efficient response time and enhance performance. Further, the optimal path requires less number of time consuming action calls which saves time and resources. Additionally, the automatic determination of the optimal path using a generic algorithm (e.g., Dijkstra's algorithm) obviates the need to explicitly hardcode the paths. Moreover, the embodiments provide robustness against the changes or extension of the status schema. For example, if the status schema is revised (e.g., the new status is added, old status is revised/edited or deleted), it is not required to manually hardcode new paths. Rather, the paths are automatically determined using the generic algorithm based upon the revised status schema.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

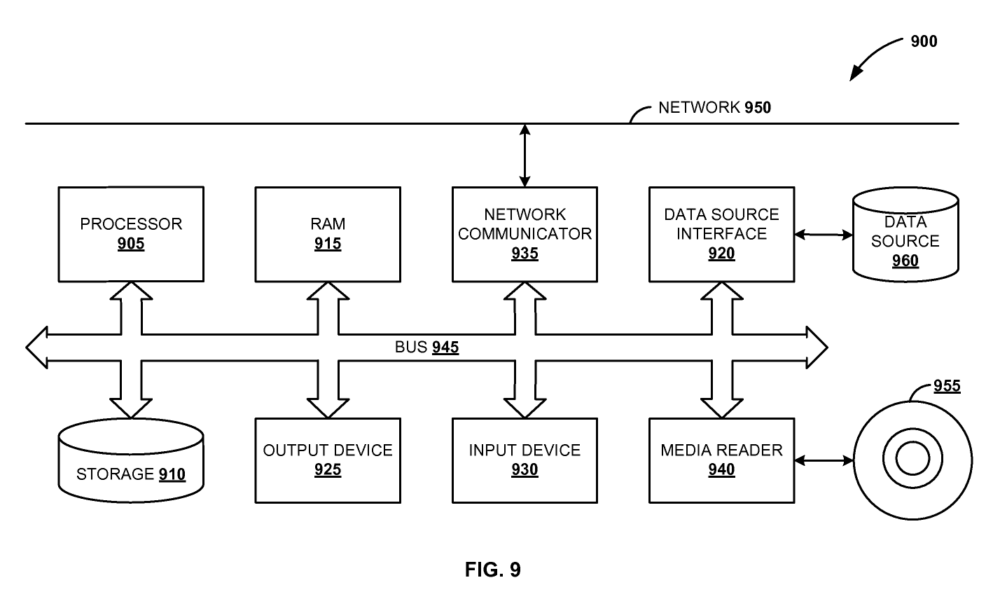

FIG. 9 is a block diagram of an exemplary computer system 900. The computer system 900 includes a processor 905 that executes software instructions or code stored on a computer readable storage medium 955 to perform the above-illustrated methods of the invention. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. The stored instructions may be further compiled to generate other representations of the instructions and dynamically stored in the RAM 915. The processor 905 reads instructions from the RAM 915 and performs actions as instructed. According to one embodiment of the invention, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by one or more computers in a network of computers causes the performance of the following operation:
the one or more computers receiving a target status related to a business object;
the one or more computers identifying a source status of the business object;
the one or more computers identifying a status schema defined for the business object, wherein the status schema includes a plurality of statuses including the source status and the target status and one or more transitions from one status to another status;
the one or more computers parsing the status schema to retrieve the one or more transitions from the source status to the target status;
the one or more computers generating a graphical representation of the one or more transitions from the source status to the target status;
the one or more computers executing an algorithm upon the graphical representation to determine an optimal sequence of transitions from the source status to the target status; and
the one or more computers processing the business object according to the optimal sequence of transitions to attain the target status.

2. The article of manufacture of claim 1, wherein the target status is received through a Web service.

3. The article of manufacture of claim 1, wherein the source status is identified from a status variable associated with the business object and wherein the status schema is identified from a metadata repository of the business object.

4. The article of manufacture of claim 1, wherein the graphical representation is a graph and wherein the graph is generated using a graph generating algorithm.

5. The article of manufacture of claim 4, wherein the graph includes the one or more statuses as one or more vertices and the one or more transitions as one or more edges and wherein each of the one or more edges represents an action performed on the business object.

6. The article of manufacture of claim 5, wherein each edge in the graph is assigned a predefined value.

7. The article of manufacture of claim 1, wherein the graphical representation is stored in a tabular format including one or more source statuses, one or more target statuses, and one or more transitions from the source statuses to the target statuses, and wherein each of the transitions represents an action performed on the business object.

8. The article of manufacture of claim 1, wherein the algorithm is a breadth first search algorithm and wherein the optimal sequence of transitions is a shortest transition from the source status to the target status.

9. The article of manufacture of claim 8, wherein the algorithm is Dijkstra's algorithm.

10. The article of manufacture of claim 1 further comprising instructions which when executed cause the one or more computers to determine if one or more predefined conditions are fulfilled before achieving the target status, wherein if the one or more predefined conditions are not fulfilled an error message is displayed on a user interface (UI) and wherein the error message is a prompt for entering one or more information related to the business object.

11. The article of manufacture of claim 1 further comprising instructions which when executed cause the one or more computers to render a confirmation message if the target status is attained.

12. A method for determining optimal sequence of status transitions for business objects implemented on a network of one or more computers, the method comprising:
the one or more computers receiving a target status related to a business object;
the one or more computers identifying a source status of the business object;
the one or more computers identifying a status schema defined for the business object,
wherein the status schema includes a plurality of statuses including the source status and the target status and one or more transitions from one status to another status;
the one or more computers parsing the status schema to retrieve the one or more transitions from the source status to the target status;
the one or more computers generating a graphical representation of the one or more transitions from the source status to the target status;
the one or more computers executing an algorithm upon the graphical representation
to determine the optimal sequence of transitions from the source status to the target status; and
the one or more computers processing the business object according to the optimal sequence of transitions to attain the target status.

13. The method of claim 12 further comprising:
the one or more computers determining if one or more predefined conditions are fulfilled before achieving the target status; and
the one or more computers displaying an error message if the one or more predefined conditions are not fulfilled before achieving the target status.

14. The method of claim 12 further comprising:
the one or more computers rendering a confirmation message if the target status is attained.

15. A computer system for determining an optimal sequence of status transitions for business objects, comprising:
a memory to store program code; and
a processor communicatively coupled to the memory, the processor configured to execute the program code to cause one or more computers in a network of computers to:
receive a target status related to a business object;
identify a source status of the business object;
identify a status schema defined for the business object, wherein the status schema includes a plurality of statuses including the source status and the target status and one or more transitions from one status to another status;
parse the status schema to retrieve the one or more transitions from the source status to the target status;
generate a graphical representation of the one or more transitions from the source status to the target status;
executing an algorithm upon the graphical representation to determine the optimal sequence of transitions from the source status to the target status; and
process the business object according to the optimal sequence of transitions to attain the target status.

16. The computer system of claim 15, wherein the graphical representation is a graph and wherein the graph includes the one or more statuses as one or more vertices and the one or more transitions as one or more edges.

17. The computer system of claim 16, wherein the processor is further configured to assign a predefined value to each edge of the graph.

18. The computer system of claim 15, wherein the processor is further configured to perform the following:
determine if one or more predefined conditions are fulfilled before achieving the target status; and
display an error message if the one or more predefined conditions are not fulfilled.

19. The computer system of claim 15, wherein the processor is further configured to render a confirmation message if the target status is attained.

20. The computer system of claim 15, wherein the algorithm is Dijkstra's algorithm and wherein the optimal sequence of transition is a shortest transition from the source status to the target status.
